(19) United States
(12) Patent Application Publication
(10) Pub. No.: US 2010/0026022 A1
(43) Pub. Date: Feb. 4, 2010

(54) APPARATUS FOR COLLECTING FECAL WASTE OF ANIMAL

(76) Inventor: Tammy Welch, Dover Foxcroft, ME (US)

Correspondence Address: JAY M. SCHLOFF, 6960 Orchard Lake Road, Suite 315, West Bloomfield, MI, 48322, US

(21) Appl. No.: 12/505,169

(22) Filed: Jul. 17, 2009

Related U.S. Application Data
(60) Provisional application No. 61/085,442, filed on Aug. 1, 2008.

(51) Int. Cl. A01K 29/00

(52) U.S. Cl. 294/1.3

(57) ABSTRACT

Disclosed is an apparatus for collecting fecal waste of an animal. The apparatus includes a container assembly. The container assembly includes a container member having an inner surface, an outer surface, a closed end portion, and an open end portion. Further, the container assembly includes a handle member configured on the outer surface of the container member. The handle member is capable of removably securing the container assembly to an item. Further, the apparatus includes a lid member disposed on the open end portion of the container member. The lid member includes at least one opening configured thereon. Furthermore, the apparatus includes at least one shovel member disposed in the container member. The at least one shovel member is capable of collecting the fecal waste of the animal.

### CROSS REFERENCE TO RELATED APPLICATIONS

The present disclosure claims priority under 35 United States Code, Section 119 on the provisional application No. 61/085,442 filed on Aug. 1, 2008, the disclosure of which is incorporated by reference.

### FIELD OF THE INVENTION

The present disclosure relates to an apparatus for collecting fecal waste of an animal, and more particularly, to an apparatus that allows a person to conveniently and hygienically collect the fecal waste of the animal.

### BACKGROUND OF THE INVENTION

In recent years, problems associated with littering caused by defecation of animals in public areas, such as parks, have enormously increased. Examples of these problems include contamination of air and water bodies, as well as the reduction of aesthetic beauty of the public areas. As a result, animal owners are legally required to dispose off fecal waste of their animals, in accordance with various local, state and federal laws.

In order to comply with the local, state and federal laws, the animal owners usually carry various utilities, such as bags and containers while taking animals out in the public areas. However, the animal owners may find carrying such utilities as cumbersome and embarrassing. Further, owners may find the disposal of the fecal waste using such utilities as unhygienic, as they more often than not require close or direct contact with the fecal waste. Therefore, there exists a need for developing an apparatus for collecting a fecal waste of an animal in a convenient and hygienic manner.

Various conventional apparatuses exist that facilitate collection of the fecal waste of animals. However, the conventional apparatuses are inconvenient to use and expensive to manufacture. Further, the conventional apparatuses are bulky, thereby making them difficult to carry. Moreover, the conventional apparatuses are composed of non biodegradable materials, which may pollute the environment.

Therefore, there exists a need to develop an apparatus that allows a person to convenient and hygienically collect the fecal waste of the animal. Further, there exists a need for an apparatus for collecting fecal waste of an animal that is inexpensive to manufacture. Furthermore, the apparatus should be lightweight and simple in arrangement, thereby making it portable. Moreover, the apparatus should be composed of biodegradable materials to minimize the negative affect of the apparatus on the environment.

### SUMMARY OF THE INVENTION

In view of the foregoing disadvantages inherent in the prior art, the general purpose of the present disclosure is to provide an apparatus for collecting a fecal waste of an animal, which includes all the advantages of the prior art, and overcomes the drawbacks inherent therein.

Accordingly, an object of the present disclosure is to provide an apparatus that allows an owner of an animal to conveniently and hygienically collect the fecal waste of the animal.

Another object of the present disclosure is to provide an apparatus for collecting the fecal waste of animal such that the apparatus is lightweight and simple in construction, thereby making it portable.

Another object of the present disclosure is to provide an apparatus for collecting the fecal waste of animal such that the apparatus is inexpensive to manufacture.

Yet another object of the present disclosure is to provide an apparatus for collecting the fecal waste of animal such that the apparatus includes components, which are composed of biodegradable materials for minimizing the negative affect thereof on the environment.

In light of the above objects, the present disclosure provides an apparatus for collecting fecal waste of an animal. The apparatus includes a container assembly. The container assembly includes a container member having an inner surface, an outer surface, a closed end portion, and an open end portion opposite to the closed end portion. Further, the container assembly includes a handle member configured to the outer surface of the container member. The handle member is capable of removably securing the container assembly to an item. The apparatus further includes a lid member disposed on the open end portion of the container member for covering the container member. The lid member includes at least one opening configured thereon. Furthermore, the apparatus includes at least one shovel member. A portion of the at least one shovel member is capable of extending out of the at least one opening of the lid member. The at least one shovel member is capable of collecting the fecal waste of the animal.

These together with the other aspects of the present disclosure, along with the various features of novelty that characterized the present disclosure, are pointed out with particularity in the claims annexed hereto and form a part of the present disclosure. For a better understanding of the present disclosure, its operating advantages, and the specified object attained by its uses, reference should be made to the accompanying drawings and descriptive matter in which there are illustrated exemplary embodiments of the present disclosure.

### BRIEF DESCRIPTION OF THE DRAWING

The advantages and features of the present disclosure will become better understood with reference to the following detailed description and claims taken in conjunction with the accompanying drawing, and in which:

FIG. 1 illustrates an exploded view of the apparatus for collecting fecal waste of an animal, according to an embodiment of the present disclosure;

FIG. 2 illustrates an assembled view of the apparatus of FIG. 1, according to an embodiment of the present disclosure; and

FIG. 3 illustrates the apparatus of FIG. 1 and FIG. 2 removably secured to an item of an animal, according to an embodiment of the present disclosure.

Like reference numerals refer to like parts throughout the description of several views of the drawings.

### DETAILED DESCRIPTION OF THE INVENTION

For a thorough understanding of the present disclosure, reference is to be made to the following detailed description, including the appended claims, in connection with the above-described drawing. Although the present disclosure is described in connection with exemplary embodiments, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The terms “a” and “an” herein do not denote a limitation of quantity, but rather denote the presence of at least one of the referenced item.

The use of “including,” “comprising,” or “having” and variations thereof herein is meant to encompass the items listed thereafter and equivalents thereof as well as additional items.

Unless limited otherwise, the terms “configured,” “disposed,” and variations thereof herein are used broadly and encompass direct and indirect attachments, couplings, and engagements. In addition, the terms “attached” and “coupled” and variations thereof are not restricted to physical or mechanical attachments or couplings.

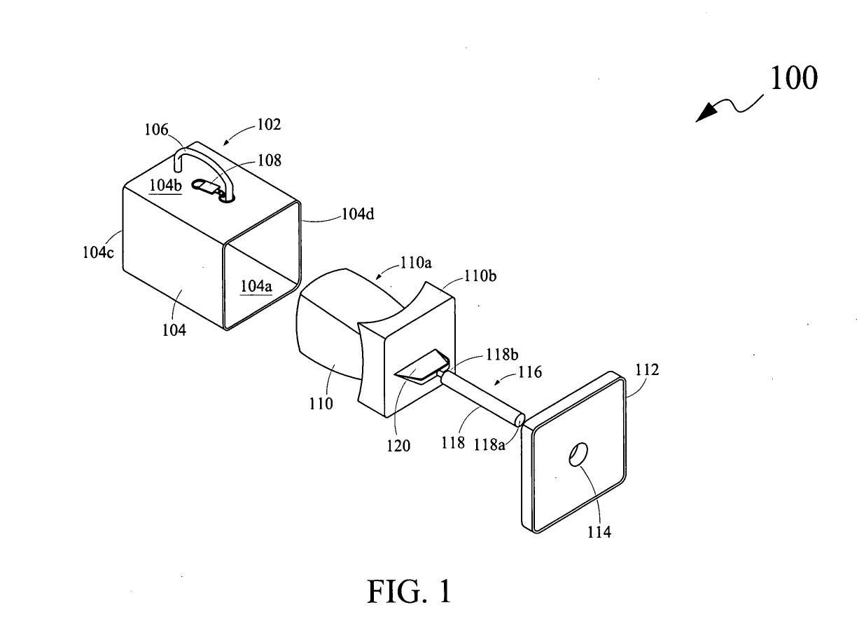

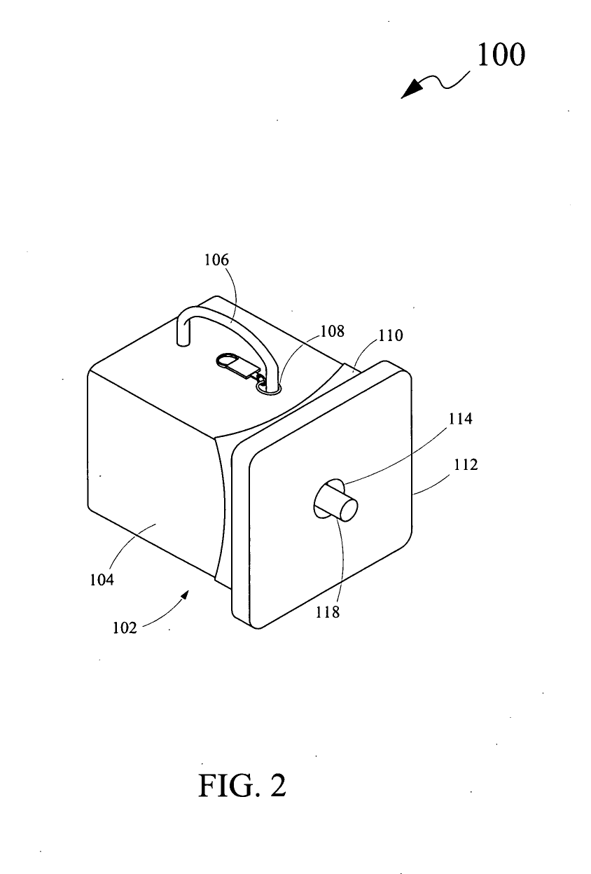

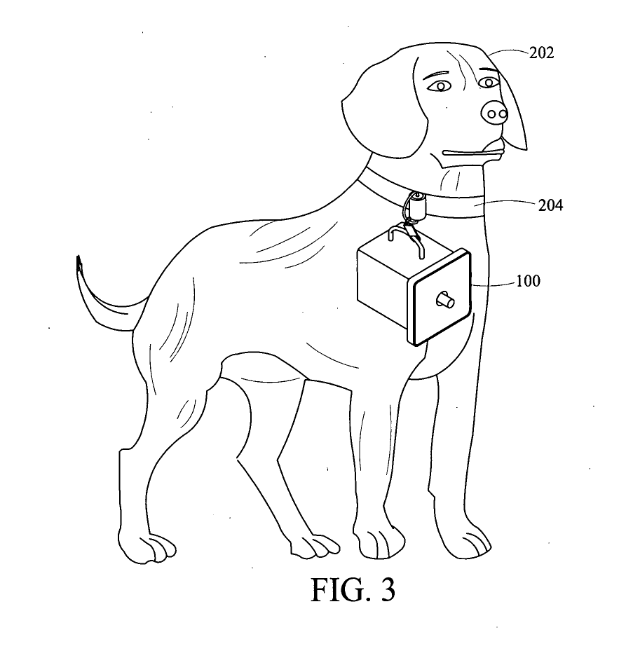

The present disclosure provides an apparatus for collecting fecal waste of an animal. Suitable examples of the animal mentioned herein may include a pet animal, such as a dog, a cat, and the like. However, the present disclosure is explained with reference to a dog. Further, it should be understood that the term ‘dog,’ as mentioned herein and throughout the present disclosure may refer to both a male and a female dog. Furthermore, it should be understood that the term ‘animal’ and ‘dog’ may be interchangeably used throughout the description of the present disclosure. Moreover, it should be understood that the term ‘fecal waste of the animal’ refers to a matter extracted by the animal through their feces. The apparatus of the present disclosure will now be explained in detail in conjunction with FIG. 1, FIG. 2 and FIG. 3.

FIG. 1 illustrates an exploded view of an apparatus 100 for collecting fecal waste of an animal, according to an embodiment of the present disclosure. As illustrated in FIG. 1, the apparatus 100 includes a container assembly 102. The container assembly 102 includes a container member 104. It should be understood that the term ‘container member’ as mentioned herein connotes a component that is capable of retaining matter therein. Accordingly, the container member 104 of the present disclosure may be capable of retaining the fecal waste of the animal therein. More specifically, the container member 104 includes an inner surface 104a, an outer surface 104b, a closed end portion 104c, and an open end portion 104d opposite to the closed end portion 104c.

As illustrated in FIG. 1, the container member 104 has a cuboidal shape. However, it should be clearly understood that the cuboidal shape of the container member 104 should not be construed as a limitation of the present disclosure. Accordingly, the container member 104 may be of any suitable known in the art, such as cylindrical shape, a spherical shape, a conical shape, oval shape, or any other suitable shape. In the exemplary embodiment of the present disclosure, the container member 104 has a length of about 5 inches to about 8 inches, a height of about 3 inches to about 5 inches, and a width of about 3 inches to about 5 inches. However, it should be clearly understood that the aforementioned dimensions of the container member 104 should not be construed as a limitation to the present disclosure. Hence, the container member 104 may be of any other suitable dimensions in accordance with the shape of the container member 104. Moreover, the container member 104 may be composed of any robust and lightweight material, such as a plastic material, a metallic material, or any other suitable material.

The container assembly 102 includes a handle member 106 configured on the outer surface 104b of the container member 104. It should be apparent to a person skilled in the art that the term ‘handle member’ as mentioned herein connotes a component for holding or securing the container assembly 102. Hence, the handle member 106 is similar to conventional handle members available in art. Further, the handle member 106 is composed of a material similar to the material used in the container member 104.

In an embodiment of the present disclosure, the handle member 106 may facilitate removable securing of the container assembly 102 to an item (not shown). More specifically, the handle member 106 includes a fastener 108 removably secured thereto. The fastener 108 removably secures the container assembly 102 to the item. Suitable examples of the fastener 108 mentioned herein may include, but are not limited to, a hook and loop fastener, a key and hook fastener, a clip and ring fastener, a buckle, and a snap ring. In an embodiment of the present disclosure, the fastener 108 is a key and hook fastener, as illustrated in FIG. 1. More specifically, the key and hook fastener includes a key, preferably composed of a metallic material. Further, the key and hook fastener includes a hook removably attached to the key. It should be understood that the hook may be composed of a material, similar to the material of the key. Moreover, the hook may include a clip, which may be adapted to receive the item in the hook of the key and hook fastener. Further, it should be understood the term ‘item’ as mentioned herein may be an accessory, such as a collar, worn by the animal. Further, the term ‘item’ may also refer to a part of the garment worn by the user. A suitable example of such part of the garment may be a belt loop of the trouser worn by the user. Further, it should be understood that the removable securing of the container assembly 102 to the item may removably secure the apparatus 100 to the item. Such removable securing will be described later in conjunction with FIG. 3.

The apparatus 100 of the present disclosure further includes a bag member 110. The bag member 110 is adapted to receive the fecal waste of the animal therein. More specifically, the bag member 110 has a closed portion 110a and an open portion 110b extending from the closed portion 110a. The closed portion 110a of the bag member 110 is removably inserted into the container member 104 to adapt to the inner surface 104a of the container member 104. Further, the open portion 110b of the bag member 110 is detachably attached to the open end portion 104d of the container member 104 using a fastener, such as a rubber band.

The bag member 110 may be composed of materials such as biodegradable materials, and wax-coated materials. In an embodiment of the present disclosure, the bag member 110 is composed of biodegradable materials, thereby minimizing the impact of the apparatus 100 on the environment. In addition, the bag member 110 may include a self-sealing zipper (not shown) adapted to seal the received fecal waste of the animal inside the bag member 110.

The apparatus 100 further includes a lid member 112 disposed on the open end portion 104d of the container member 104. It should be apparent to a person skilled in the art that the term ‘lid member’ as mentioned herein connotes a component, which ensures covering of the container member 104. Further, the lid member 112 ensures that the odor and germs associated with the received fecal waste of the animal in the bag member 110 is confined to the container member 104.

It should be understood that the lid member 112 may be of a shape and a size in accordance with the shape and the size of the container member 104. In an embodiment of the present disclosure, the lid member 112 has a rectangular shape. Further, the lid member 112 has a length of about 3 inches to about 5 inches and a width of about ½ inch. Further, the lid member 112 includes at least one opening, such as opening 114, configured thereon. As disclosed herein, in the present embodiment, the lid member 112 is shown to include a single opening, i.e. the opening 114, configured thereon. However, in an alternative embodiment, the lid member 112 may include multiple openings (not shown).

The apparatus 100 further includes at least one shovel member, such as a shovel member 116 (hereinafter referred to as ‘shovel member 116’). The shovel member 116 facilitates collection of the fecal waste of the animal in the container member 104 by a user. It should be understood that the shovel member 116 as mentioned herein may be similar to conventional ‘shovel members’ existing in the art. Further, it should be apparent that use of the shovel member 116 for collecting the fecal waste may prevent any possibility of the user making contact with the fecal waste.

The shovel member 116 may include an elongated rod 118 having a first end portion 118a and a second end portion 118b. The first end portion 118a of the elongated rod 118 may be held by the user. The shovel member 116 may further include a blade 120 removably attached to the second end portion 118b of the elongated rod 118. In an embodiment of the present disclosure, the elongated rod 118 is composed of a material, such as wood, and has a length of about 6 inches and a diameter of about ½ inch. Further, the blade 120 is composed of a material, such as metal. Furthermore, the blade 120 has a length of about 3½ inches and a width of about 3 inches. Overall, the shovel member 116 may have a length of about 9 inches.

The shovel member 116 is adapted to be removably disposed inside the container member 104. More specifically, a portion of the elongated rod 118 of the shovel member 116 is capable of extending out of the opening 114 of the lid member 112 to removably dispose the shovel member 116 in the container member 104. However, such disposing of the shovel member 116 inside the container member 104 should not be construed as a limitation to the present disclosure. Therefore, in another embodiment of the present disclosure, the shovel member 116 may be fully disposed inside the container member 104.

Now referring to FIG. 2, there is illustrated an assembled view of the apparatus 100, according to an embodiment of the present disclosure. Further, as described above, the apparatus 100 of the present disclosure may be removably secured to an item. Such removable securing of the apparatus 100 to the item is shown in conjunction with FIG. 3.

FIG. 3 illustrates the removably securing of the apparatus 100 to an animal 202, and more particularly to an item 204 of the animal 202, according to an embodiment of the present disclosure. The removable securing of the apparatus 100 to the item 204 of the animal 202, makes the apparatus 100 convenient to carry. As illustrated in FIG. 3, the animal 202 is a dog, and the item 204 of the animal 202 is a collar of the dog.

In addition to the foregoing description of the apparatus 100, and with respect to shapes and sizes of various components thereof, it should be understood that the apparatus 100 may be manufactured in various customized sizes. In an embodiment of the present disclosure, the apparatus 100 is manufactured in two sizes. The first size is a small size having a length of about 5½ inches, a height of about 3½ inches, and a width of about 4 inches. The second size is a large size having a length of about 7 inches, a height of about 4½ inches and a width of about 4½ inches. Further, the apparatus 100 may be manufactured in various colors, which may be selected according to the preference of the users of the apparatus 100. Furthermore, the apparatus 100 may include a logo embedded or imprinted on at least one of the various components thereof. In an embodiment of the present disclosure, the apparatus 100 may include a logo ‘POOPIE ELIMINATOR—THE ULTIMATE POOPIE SCOOPER’ embedded or imprinted on the container member 104. Moreover, the apparatus 100 may also include various designs embedded or imprinted thereon.

Based on the foregoing, the present disclosure provides an apparatus, such as the apparatus 100, for conveniently and hygienically collecting a fecal waste of an animal. The disclosed apparatus is lightweight and may be secured to an item, thereby making it portable. Further, the apparatus includes components, which are composed of biodegradable materials for minimizing the negative affect thereof on the environment. Furthermore, the apparatus is inexpensive to manufacture, thereby making it easily affordable by users. Moreover, the apparatus may be provided in various customized sizes, shapes, and designs.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present disclosure.

What is claimed is:

1. An apparatus for collecting fecal waste of an animal, the apparatus comprising,
a container assembly comprising,
a container member having an inner surface, an outer surface, a closed end portion and an open end portion opposite to the closed end portion, and
a handle member configured on the outer surface of the container member, the handle member capable of removably securing the container assembly to an item;
a lid member removably disposed on the open end portion of the container member for covering the container member, the lid member having at least one opening configured thereon; and
at least one shovel member removably disposed in the container member, a portion of the at least one shovel member capable of extending out of the at least one opening of the lid member, the at least one shovel member capable of collecting the fecal waste.

2. The apparatus of claim 1 further comprising a bag member capable of being removably inserted into the container member for receiving the fecal waste.

3. The apparatus of claim 2, wherein the bag member is composed of biodegradable material.

4. The apparatus of claim 2, wherein the bag member is composed of wax-coated material.

5. The apparatus of claim 1, wherein the handle member further comprises a fastener removably secured to the handle member, the fastener capable of removably securing the container assembly to the item.

6. The apparatus of claim 5, wherein the fastener comprises a key and hook fastener.
